(19) United States
(12) Patent Application Publication
(10) Pub. No.: US 2015/0026085 A1
(43) Pub. Date: Jan. 22, 2015

(54) GENERATING A CURRICULUM VITAE UPDATE REPORT

(71) Applicant: International Business Machines Corporation, Armonk, NY (US)

(72) Inventors: Cristiana D'Amore, Rome (IT); Alessandro Donatelli, Rome (IT); Randa Salem, Rome (IT)

(21) Appl. No.: 13/944,216

(22) Filed: Jul. 17, 2013

(51) Int. Cl. G06Q 10/10

(52) U.S. Cl. CPC G06Q 10/1053
USPC 705/321

(57) ABSTRACT

In a method for compiling information suitable for assisting in creating or updating curriculum vitae (CV), a processor analyzes a plurality of entries to determine that one or more entries of the plurality of entries contains information relevant to creating or updating a CV. A processor organizes the one or more entries containing information relevant to creating or updating a CV. A processor generates a report suitable for assisting in creating or updating a CV using the entries organized into the one or more topics.

### FIELD OF THE INVENTION

The present invention relates generally to the field of data retrieval and compilation, and more particularly to gathering employment related information and generating a report to assist in creating or updating a résumé or curriculum vitae (CV).

### BACKGROUND OF THE INVENTION

A curriculum vitae or résumé (hereinafter both documents will be collectively referred to as “CV”) provides an overview of a person's experience and qualifications and is typically used by job seekers looking for employment. A CV may recap major activities, events and accomplishments of an individual. An individual will often update their CV anytime they enter the job market to reflect their most recent and meaningful employment-related accomplishments. Different careers require different skill sets, so the type of information an individual may want include on their CV can vary greatly.

There are a number of available electronic office tools that store or otherwise log information related to employment tasks and accomplishments. Electronic calendaring and/or email applications can be used to schedule events, create and store event descriptions, and manage projects over an extended time period. Travel reservation and expense reimbursement tools may indicate destinations traveled, seminars attended, or other job related information. Other tools exist that allow employees to track hours or tasks for billing and/or work efficiency purposes.

### SUMMARY

Aspects of an embodiment of the present invention disclose a method, computer program product, and computing system for compiling information suitable for assisting in creating or updating curriculum vitae (CV). A processor analyzes a plurality of entries to determine that one or more entries of the plurality of entries contains information relevant to creating or updating a CV. A processor organizes the one or more entries containing information relevant to creating or updating a CV. A processor generates a report suitable for assisting in creating or updating a CV using the entries organized into the one or more topics.

### BRIEF DESCRIPTION OF THE SEVERAL VIEWS OF THE DRAWINGS

FIG. 1 depicts a diagram of a computing system in accordance with one embodiment of the present invention.

FIG. 2 depicts a flowchart of the steps of an entry crawler function executing within the computing system of FIG. 1, for retrieving entries from a calendar client program and adding relevant entries to a CV database, for further analysis by a topics creator function.

FIG. 3 depicts a flowchart of the steps of a topics creator function executing within the computing system of FIG. 1, for receiving previously compiled entries from a CV database, and applying correlation rules to each entry to create topics and organize entry information in a CV topic report.

FIG. 4 is an exemplary user interface to a calendaring client program in accordance with one embodiment of the present invention.

FIG. 5 is an exemplary CV topic report window as displayed to a user on a client computing device in accordance with one embodiment of the present invention.

FIG. 6 depicts a block diagram of components of the client computing device and the server in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the Figures.

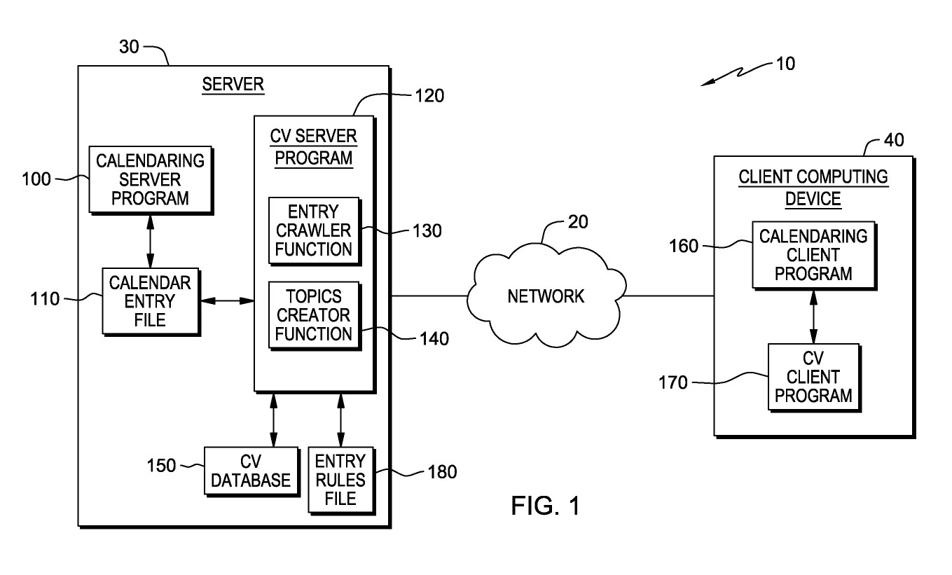

FIG. 1 depicts a diagram of computing system 10 in accordance with one embodiment of the present invention. FIG. 1 provides an illustration of one embodiment and does not imply any limitations with regard to the environments in which different embodiments may be implemented.

In the depicted embodiment, computing system 10 includes server 30 and client computing device 40 interconnected over network 20. Network 20 may be a local area network (LAN), a wide area network (WAN) such as the Internet, a cellular data network, any combination thereof, or any combination of connections and protocols that will support communications between server 30 and client computing device 40 in accordance with embodiments of the invention. Network 20 may include wired, wireless, or fiber optic connections. Computing system 10 may include additional computing devices, servers, or other devices not shown.

Server 30 may be a management server, a web server, or any other electronic device or computing system capable of receiving and sending data. In some embodiments, server 30 may be a laptop computer, tablet computer, netbook computer, personal computer (PC), a desktop computer, a personal digital assistant (PDA), a smart phone, or any programmable electronic device capable of communicating with client computing device 40 via network 20. In other embodiments, server 30 may represent a server computing system utilizing multiple computers as a server system, such as in a cloud computing environment.

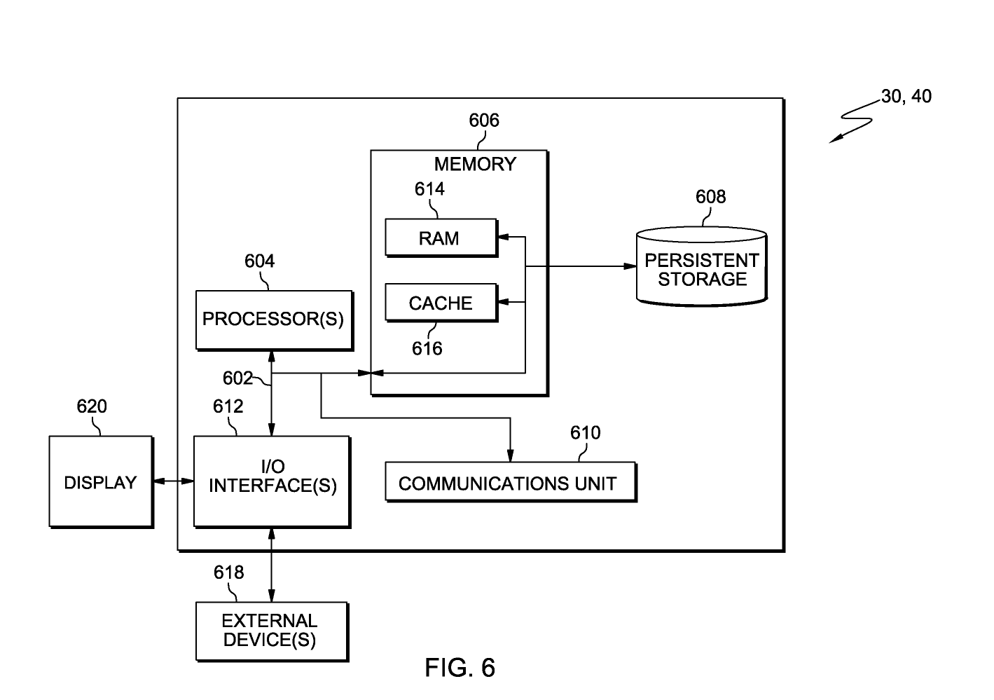

Server 30 contains calendaring server program 100, CV server program 120, entry crawler function 130, topics creator function 140, calendar entry file 110, CV database 150, and entry rules file 180. Server 30 may include components, as depicted and described in further detail with respect to FIG. 6.

Client computing device 40 may be a desktop computer, laptop computer, netbook computer, tablet computer, personal digital assistant (PDA), or smart phone. In general, client computer 40 may be any electronic device or computing system capable of sending and receiving data, and communicating with server 30 over network 20. Client computing device 40 contains calendaring client program 160 and CV client program 170. Client computing device 40 may include components, as depicted and described in further detail with respect to FIG. 6.

Calendaring client program 160 may be a dedicated client calendaring program, a function integrated within another program, or any other program or function that can communicate with calendaring server program 100 and provide a user interface for viewing, creating, receiving, and storing employment related entries. Employment related entries may include calendar entries, billable hour logs, time logs, emails, project logs, expense reports, travel reports, or any other entry, event, log, or piece of information related to employment. A calendaring client program is not necessary to the present invention, and is presented merely as an example. Rather, other embodiments of the invention may access billable hours client programs, travel reservation client programs, event log client programs, email client programs, or any other client programs capable of creating and storing employment related entries. One or more of these types of client programs may be accessed by embodiments of the present invention.

In the depicted embodiment, a calendar entry, or other employment related entry, may be created by selecting a date and time for the entry and entering a description for the entry. Exemplary embodiments of the present invention may also include a CV topic field to allow for the addition of one or more CV tags to an entry. CV tags may be related to possible CV sections, e.g., professional growth, customer relations, and achievement related tags. In embodiments that use or access different types of client programs, CV tags may be similarly applied to the respective entries of each client program.

Calendaring server program 100 operates to store and manage employment related entries. In one embodiment, calendaring server program 100 stores all employment related entries that it manages in calendar entry file 110. Calendaring server program 100 may also store, in calendar entry file 110, CV tags corresponding to employment related entries. In one embodiment, calendaring server program 100 resides on server 30. In other embodiments, calendaring server program 100 may reside on another server, another computing device, or client computing device 40, provided that calendaring server program 100 is accessible to calendaring client program 160 and CV server program 120, and provided that calendaring server program 100 has access to calendar entry file 110.

Calendar entry file 110 may be a repository that may be written and read by calendaring server program 100 and may be accessible to CV server program 120. In some embodiments, files may exist to store employment related entries from other programs. For instance, a billable hours program may have a similarly associated billable hours entry file. In some embodiments, multiple entry files that store employment related entries from different corresponding program sources may be combined into a single file or database and may store employment related entries from multiple sources. In one embodiment, calendar entry file 110 resides on server 30. In other embodiments, calendar entry file 110 may reside on another server, another computing device, or client computing device 40, provided that calendar entry file 110 is accessible to calendaring server program 100 and CV server program 120.

CV client program 170 may be a dedicated client CV topic report generation program, a function integrated within another program, or any program that can communicate with CV server program 120 and provide a user interface for defining rules, tagging entries with CV tags, and requesting and viewing CV topic reports. A CV topic report may be a report suitable for assisting in creating or updating a CV.

CV server program 120 operates to retrieve employment related entry information according to a set of entry relevance rules and compile the information into a CV topic report. A CV topic report may be a report suitable for assisting in creating or updating a CV. In one embodiment, CV server program 120 includes two functions: entry crawler function 130 and topics creator function 140. In one embodiment, CV server program 120 resides on server 30. In other embodiments, CV server program 120 may reside on another server, another computing device, or client computing device 40, provided that CV server program 120 is accessible to CV client program 170, and provided that CV server program 120 has access to calendar entry file 110, CV database 150, and entry rules file 180.

Entry crawler function 130 operates to retrieve employment related entry information from calendar entry file 110 and calendaring server program 100 based upon a set of entry relevance rules. Entry crawler function 130 stores retrieved entries to CV database 150 for use by topics creator function 140. In some embodiments, entry crawler function 130 may retrieve employment related entry information from entry storage files associated with other programs. For example, entry crawler function 130 may be able to communicate with billable hours software, email client software, travel reservation software, or other employment related entry software. One embodiment of entry crawler function 130 may be capable of retrieving employment related entry information from entry storage files associated with multiple programs.

Entry relevance rules may provide a set of instructions to entry crawler function 130. Entry relevance rules may contain certain keyword(s), phrase(s), and/or other information that should be included or excluded from each searched employment related entry. Entry crawler function 130 will store all entries that meet entry relevance rule requirements to CV database 150. For example, entry crawler function 130 may follow an entry relevance rule that instructs entry crawler function 130 to ignore all meeting entries with “department meeting” listed somewhere in the subject heading. Entry relevance rules may be configurable based upon user preference. Employment related entries that do not meet entry relevance rule requirements will not be stored to CV database 150 and will not be analyzed by topics creator function 140 as the function generates a CV topic report.

Entry rules file 180 is a repository that may be written and read by CV server program 120, entry crawler function 130, and topics creator function 140. Entry relevance rules may be stored in entry rules file 180. In addition, correlation rules and correlation threshold information may be stored to entry rules file 180, for access by topics creator function 140. In one embodiment, entry rules file 180 resides on server 30. In other embodiments, entry rules file 180 may reside on another server, another computing device, or client computing device 40, provided that entry rules file 180 is accessible to CV server program 120, entry crawler function 130, and topics creator function 140.

CV database 150 is a repository that may be written and read by CV server program 120, entry crawler function 130, and topics creator function 140. CV database 150 may store employment related entry information gathered by entry crawler function 130. CV database 150 may also store topic and employment related entry information created and organized by topics creator function 140. In one embodiment, CV database 150 resides on server 30. In other embodiments, CV database 150 may reside on another server, another computing device, or client computing device 40, provided that CV database 150 is accessible to CV server program 120, entry crawler function 130, and topics creator function 140.

Topics creator function 140 operates to retrieve and organize employment related entry information gathered by entry crawler function 130 and generate a CV topic report. Topics creator function 140 may sort employment related entry information into topics. For example, topics may represent potential achievements or recommended sections to add to a CV. Topics creator function 140 may create topics by analyzing and searching through employment related entries stored on CV database 150, as compiled by entry crawler function 130. Topics creator function 140 may compare each employment related entry to created topics by using a set of correlation rules and a correlation threshold.

In the present embodiment, correlation rules are used by topics creator function 140 to determine whether an employment related entry belongs to a topic that already exists, or if a new topic should be created. Correlation rules may be previously defined and/or customizable by a user at client computing device 40 using CV client program 170. Correlation rules may look to the subject, invitees, CV tags, or description keywords to determine within what topic, if any topic, an employment related entry might belong.

In one embodiment, topics creator function 140 uses text analytics to parse through all available employment related entry information and create topics based on keywords or common themes within employment related entry descriptions or linked materials. Using natural language processing and at least one set of dictionaries and rules, topics creator function 140 can perform text analytics on individual employment related entries to create topics. Text analytics can be performed using an Unstructured Information Management Architecture (UIMA) application configured to analyze unstructured information to discover patterns relevant to topics creator function 140 by processing plain text and identifying entities or relations.

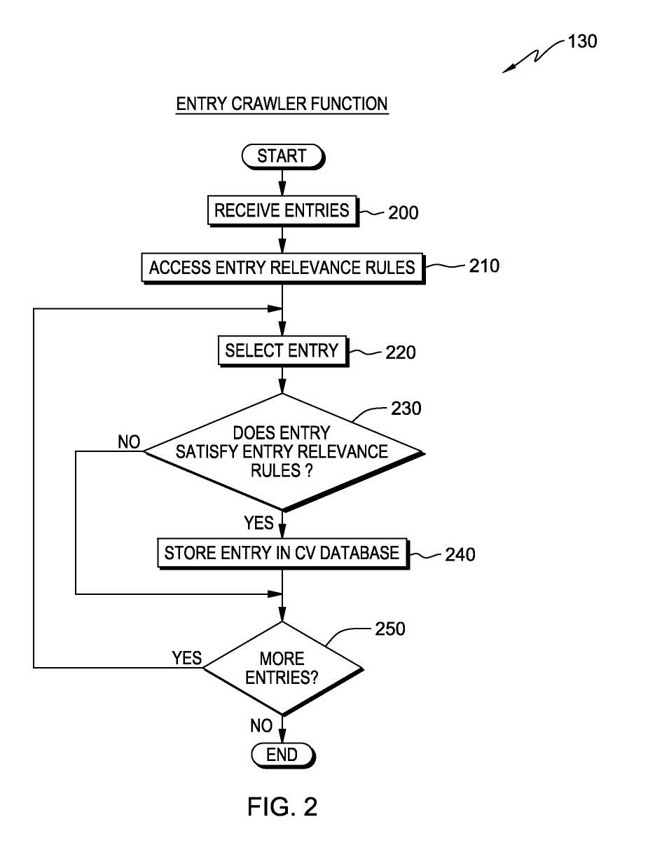

FIG. 2 depicts a flowchart of the steps of entry crawler function 130, a function of CV server program 120, executing within the computing system of FIG. 1. Entry crawler function 130 adds relevant employment related entries to CV database 150, for further analysis by topics creator function 140, in accordance with one embodiment of the present invention. In one embodiment, entry crawler function 130 retrieves entries from calendaring software. Some embodiments of entry crawler function 130 may retrieve entries from billable hours software, information logging software, email client software, or other similar software. Other embodiments of entry crawler function 130 may retrieve entries from multiple types of software.

In one embodiment, initially, a user at client computing device 40 composes at least one entry, using calendaring client program 160. An entry could be an event, task, conference invitation, or other type of entry. Calendaring client program 160 sends the entry to calendaring server program 100. Calendaring server program 100 stores the entry to calendar entry file 110. In some embodiments, rather than composing entries with a calendaring program, a user at client computer 40 may compose entries using other programs such as a billable hours program, a travel reservation program, an email client program, a notebook program, or some other electronic entry storage program.

In exemplary embodiments, a user at client computing device 40 may have the option to tag a new employment related entry with a CV topic tag. CV topic tagging may be accomplished by an add-on field within the window for creating a new entry. A CV topic tag may be customizable and may include topics relevant to creating or updating a CV. For example, CV topic tags may include customer relations related tags such as customer deals, customer visits, or a customer workshop/demo. Other CV topic tags may be related to professional growth activities such as mentoring, education, seminars, or workgroups. In general, CV topic tags may help organize entries by potential CV sections or employment accomplishments.

In one embodiment, a user at client computing device 40 composes one or more entry relevance rules, using CV client program 170. In some embodiments, a list of default entry relevance rules may be present. CV client program 170 sends the rule(s) to CV server program 120. CV server program 120 stores the entry relevance rules to entry rules file 180.

Entry relevance rules are rules used by entry crawler function 130 to determine whether or not an entry retrieved by entry crawler function 130 is relevant to the current CV topic report being generated. Entry relevance rules can be customized by a user and may enable entry crawler function 130 to selectively store employment related entry information to CV database 150 for further analysis by topics creator function 140. If entry relevance rules are not met when entry crawler function 130 analyzes a particular entry, entry crawler function 130 will not store the entry information to CV database 150. A user may create entry relevance rules to filter out information they consider not relevant to creating or updating a CV. Entry relevance rules may be created with regards to date ranges, subject content, description content, invitees, CV tags, or other information included in an entry. Entry relevance rules may be inclusionary or exclusionary. For example, an exclusionary rule may say that entry crawler function 130 shall ignore all meeting entries with the subject “department meeting.” An inclusionary rule may be that entry crawler function 130 shall include all entries with the term “seminar.” Conflicting entry relevance rule scenarios may be resolved by assigning rule priorities or a rule application order.

After a number of entries have been created, and entry relevance rules have been set, a user may wish to generate a CV topic report. At client computing device 40, a user may send a request for a CV topic report to CV server program 120, through CV client program 170. CV server program 120 will retrieve entries from calendar entry file 110, or an entry file associated with another type of program, for use by entry crawler function 130.

In step 200, entry crawler function 130 receives one or more entries from calendar entry file 110. In one embodiment, entry crawler function 130 accesses calendar entry file 110 and retrieves the one or more calendar entries. In another embodiment, entry crawler function 130 may request the one or more calendar entries from calendar entry file 110. The entries may include all entries stored to calendar entry file 110. In another embodiment, a user may specify, initially, a time period of entries to be retrieved (e.g., only entries created during a time period, event entries that occurred during a time period, etc.).

In step 210, entry crawler function 130 accesses one or more entry relevance rules from entry rules file 180. In some embodiments the one or more entry relevance rules may be a set of default rules. In other embodiments, the one or more entry relevance rules may be a customized set of entry relevance rules created by a user for the generation of the particular CV topic report. For example, a relevance rule may state that entry crawler function 130 should disregard all meeting entries with the subject heading “department meeting.”

In step 220, entry crawler function 130 selects a calendar entry to analyze. Embodiments of entry crawler function 130 may select calendar entries to be analyzed by date, subject, or any other organized method. In one embodiment, entry crawler function 130 selects calendar entries to analyze by the date the entry was created or the date the entry occurred, if the entry was an event or meeting, starting with the most recent entry.

In decision 230, entry crawler function 130 determines whether the selected entry satisfies inclusionary entry relevance rules, or alternatively, does not satisfy exclusionary entry relevance rules, as previously discussed. Entry relevance rules may vary and be customizable based upon user preference. In the event of conflicting rules, priority rules may also exist to determine an order or weighing process. For instance, certain entry relevance rules may be primary and other entry relevance rules may be secondary and reliant upon the satisfaction of the primary rule before coming into effect. In another example, a set of rules may take precedence and determine that an entry should be added to CV database 150 prior to the execution of later rules. If the entry fails to satisfy entry relevance rules (decision 230, no branch), entry crawler function 130 will not store the calendar entry to CV database 150 and determine if there are still more entries to be similarly analyzed (decision 250). If there are still more calendar entries to analyze, entry crawler function 130 will repeat the process with the next calendar entry. Entry crawler function 130 determines that there are calendar entries left to analyze by comparing the calendar entries analyzed to the pool of all previously received calendar entries (see step 200).

If entry crawler function 130 determines that the calendar entry satisfies entry relevance rules (decision 230, yes branch), entry crawler function 130 will store the employment related entry information to CV database 150 (step 240) for access by topics creator function 140.

In decision 250, entry crawler function 130 determines whether or not there are additional entries to analyze. If there are more entries left to analyze, (decision 250, yes branch), entry crawler function selects the next sample entry to analyze (step 220) from the pool of received entries (see step 200). Entry crawler function 130 determines that there are calendar entries left to analyze by comparing the calendar entries analyzed to the pool of all previously received calendar entries (see step 200).

If there are no more entries left to analyze (decision 250, no branch), then all relevant entries (according to applied entry relevance rules) have been stored in CV database 150, and topics creator function 140 will proceed to generate a CV topic report.

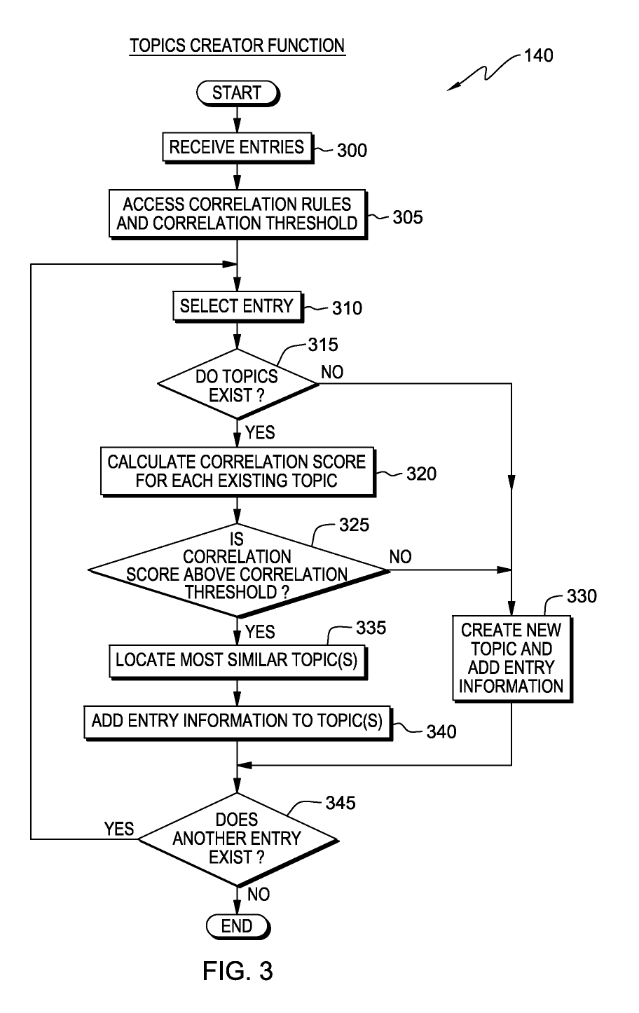

FIG. 3 depicts a flowchart of the steps of topics creator function 140, a function of CV server program 120, executing within the computing system of FIG. 1. Topics creator function 140 executes after employment related entries have been gathered by entry crawler function 130 and stored to CV database. Topics creator function 140 receives the previously compiled employment related entries from CV database 150, and applies correlation rules to create topics and organize previously compiled employment related entry information, in accordance with one embodiment of the present invention.

In one embodiment, initially, a user at client computing device 40 sends a request to compile a CV topic report, using CV client program 170. CV client program 170 sends the request to CV server program 120 and entry crawler function 130 compiles relevant employment related entries, as discussed with regards to FIG. 2, and stores the relevant employment related entries to CV database 150.

In step 300, topics creator function 140 receives the one or more employment related entries that entry crawler function 130 previously stored to CV database 150. In one embodiment, topics creator function 140 accesses CV database 150 and retrieves the one or more employment related entries. In one embodiment, topics creator function 140 may receive the employment related entries from CV database 150 after entry crawler function 130 has completed its function.

After receiving one or more employment related entries from CV database 150 (step 300), topics creator function 140 retrieves one or more correlation rules and a correlation threshold. In one embodiment, the one or more correlation rules and the correlation threshold may be retrieved from entry rules file 180. The one or more correlation rules and the correlation threshold may be predefined, or they may be customizable by the user.

Correlation rules are rules used by topics creator function 140 to create a correlation score. Topics creator function 140 uses correlation rules to compare an employment related entry to generated topics. There may be one or more correlation rules. Correlation rules may be created and customized by a user on client computing device 40, using CV client program 170. Each correlation rule may assign a numerical score to the analyzed employment related entry as compared to each topic. For example, a correlation rule may be satisfied if certain keywords are in the employment related entry's subject line. Each word that appears in the subject line may contribute towards the score. Another correlation rule may state that entries in a topic must have the same list of invitees. Correlation rules may be created based on any information in an employment related entry.

After topics creator function 140 applies the correlation rules to an employment related entry, correlation scores are generated by adding up the results from each correlation rule. For each employment related entry analyzed, a separate correlation score will be assigned for each existing topic based on comparisons to the existing topics.

Once correlation scores have been generated for an employment related entry, comparing the employment related entry to each topic, topics creator function 140 compares the correlation scores to the correlation threshold. The correlation threshold may be a number that is predefined or customizable by a user. If all the correlation scores for an employment related entry are below the correlation thresholds for each existing topic, then topics creator function 140 will create a new topic for the employment related entry. If any of the correlation scores are above the correlation threshold, then topics creator function 140 will add the information to the topic most closely matching (i.e., the topic with the highest correlation score). In another embodiment, topics creator function 140 may add employment related entry information to every topic that has a correlation score above the topic's correlation threshold.

In response to retrieving one or more correlation rules and the correlation threshold (step 305), topics creator function 140 selects an employment related entry (step 310). Topics creator function may select an employment related entry by date, subject heading, or any other organized method. In one embodiment the employment related entry is retrieved from a database, such as CV database 150.

In decision 315, topics creator function 140 determines whether topics already exist. If the employment related entry being analyzed is the first employment related entry to be analyzed, there typically will not be existing topics. However, in some embodiments, topics creator function 140 may update an already created CV topic report that contains previously stored topics. If no topics exist (decision 315, no branch), topics creator function 140 will create a new topic and store the topic and employment related entry information to CV database 150 (step 330). Topics creator function 140 will then determine if there is another employment related entry left to analyze (see decision 345). If another employment related entry does not exist (decision 345, no branch), the function is complete and the information will be displayed to the user as a CV topic report (see FIG. 5). If another employment related entry does exist (decision 345, yes branch), topics creator function 140 will retrieve the next employment related entry from CV database 150 (step 310). In one embodiment, topics creator function 140 will determine if another employment related entry exists by comparing the pool of employment related entries gathered from CV database 150 to all employment related entries previously analyzed.

In decision 315, if topics creator function 140 determines that there are preexisting topics (decision 315, yes branch), topics creator function 140 will apply correlation rules and calculate correlation scores comparing the employment related entry to each existing topic (step 320). For example, there may be a list of three correlation rules: for each matching word in the subject heading—5 points; for each matching invitee, author, or individual listed—2 points; for each matching CV topic tag—25 points. Topics creator function 140 may calculate a correlation score by comparing the employment related entry to each topic and applying the given correlation rules, then adding up the resulting total for each topic.

After generating correlation scores, topics creator function 140 compares the generated correlations scores to the predetermined correlation threshold (decision 325). The correlation threshold may be customizable by the user. If the correlation score is below the correlation threshold (decision 325, no branch), topics creator function 140 creates a topic and stores the topic and employment related entry information to CV database 150. Following topic creation, topics creator function 140 determines whether another employment related entry exists (decision 345). If another employment related entry does not exist (decision 345, no branch), the function is complete and the information will be displayed to the user as a CV topic report (see FIG. 5). If another employment related entry does exist, (decision 345, yes branch), topics creator function 140 will retrieve the next employment related entry and perform the analysis previously described.

If the correlation score is above the correlation threshold (decision 325, yes branch), this indicates that, according to the correlation rules being applied, the employment related entry is sufficiently similar to be included within that topic. In response, topics creator function 140 will locate the most similar topic (step 335). The most similar topic may be located by looking to the highest correlation score among the existing topics. In one embodiment, topics creator function 140 will locate the topic with the highest correlation score. In another embodiment, topics creator function 140 will locate all topics with correlation scores above the correlation threshold.

In step 340, topics creator function 140 adds employment related entry information from the selected entry to the identified similar topic and stores the added employment related entry information to CV database 150. In another embodiment, topics creator function 140 may add the employment related entry information from the selected entry to multiple identified topics. After adding the employment related entry information to the topic or topics, topics creator function 140 will determine if another employment related entry exists (decision 345) in the manner previously described. If an employment related entry does not exist (decision 345, no branch), the function is complete and the CV topic report will be displayed. If another employment related entry does exist, the new employment related entry will be similarly analyzed and compared to all existing topics in the CV topic report.

Exemplary embodiments of the present invention will display the information in a CV topic report window similar to CV topic report window 50 of FIG. 5.

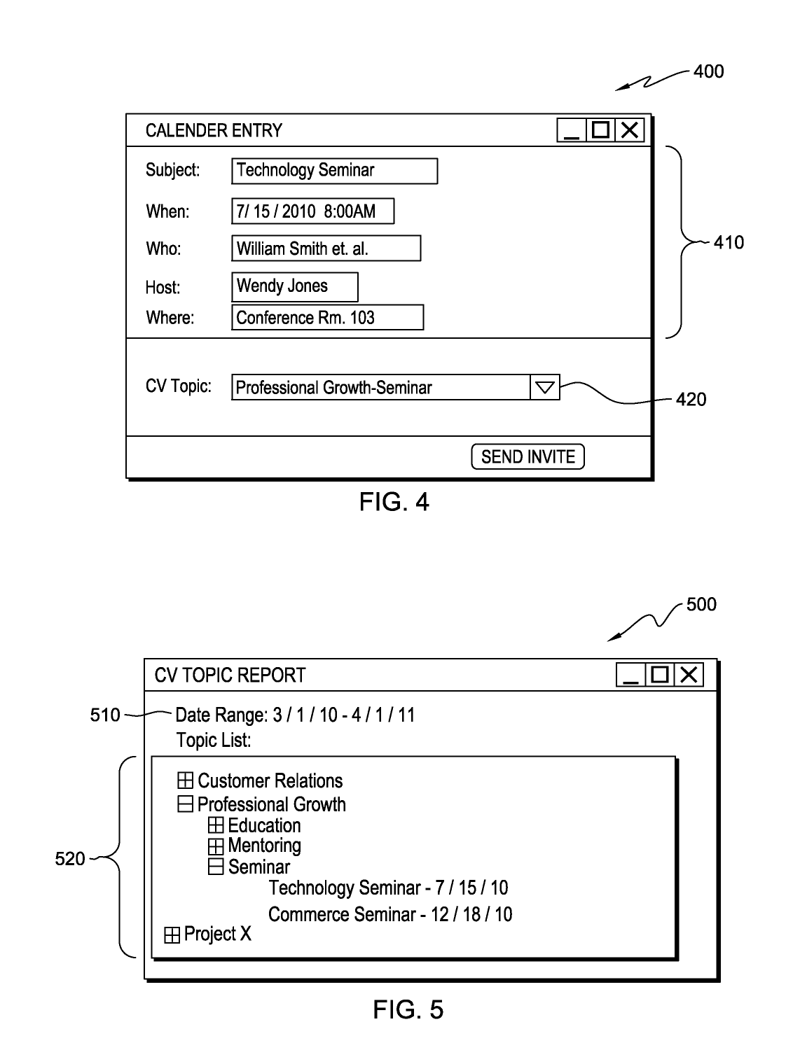

FIG. 4 is an exemplary user interface window to a calendaring client program in accordance with one embodiment of the present invention. User interface window 400 may be a user interface within calendaring client program 160 of client computing device 40 of FIG. 1. User interface window 400 allows a user to create, receive and respond to calendar entries, and add CV topic tag information to calendar entries. In the depicted embodiment, user interface window 400 is shown as viewed by a host (i.e., Wendy Jones) to a calendar entry event, in the current depiction a meeting invitation entry, before sending the meeting invitation entry to a set of invitees.

User interface window 400 of calendaring client program 160 contains a number of information fields 410 and CV topic field 420. User interface window 400 is exemplary of a meeting invitation entry that is about to be sent by a host (i.e., Wendy Jones), to a set of invitees (i.e., William Smith, et. al.). User interface window 400 may contain information fields 410. Information fields 410 may contain information about the calendar entry such as the subject, date, time, invitees, location, or telephone number for teleconference services. The depicted user interface window 400 is a meeting invitation entry; however, other types of calendar entries may be created. Calendar entries may instead be reminders, teleconferences, deadlines, events or other entries. In other embodiments, user interface window 400 may be an entry window for another type of software, such as billable hours software, travel reservation software, event logging software, email client software, or any other software capable of creating and storing employment related entries.

User interface window 400 contains CV topic field 420. CV topic field may contain a number of predefined or customizable tags. CV topic tags may include topics relevant to creating or updating a CV. For example, CV topic tags may include customer relations related tags such as customer deals, customer visits, or a customer workshop/demo. CV topic tags may be related to professional growth activities such as mentoring, education, seminars, or workgroups. In general, CV topic tags may help a user organize employment related entries by potential CV sections or employment accomplishments. In one embodiment, CV topic tag information will be stored to calendar entry file 110 along with the other information contained in the calendar entry.

FIG. 5 is an exemplary CV topic report window as displayed to a user on a client computing device in accordance with one embodiment of the present invention. CV topic report window 500 may be a CV topic report window generated by CV client program 170 and displayed on client computing device 40. CV topic report window 500 may contain a list of topics generated and employment related entry information gathered and organized by CV server program 120. In the depicted embodiment, CV topic report window 500 is shown as viewed by a user who requested through CV client program 170 that a CV topic report be created using a date range of Mar. 1, 2010 to Apr. 1, 2011. In the depicted embodiment, the user selected correlation rules based on CV topic tags that allowed the CV topic report to be organized according to CV topic tags. Other embodiments may have CV topic report organized by date, subject, invitee(s), or other organizational methods, based on user selected correlation rules and correlation threshold information.

CV topic report window 500 contains date range field 510 and topic list 520. Date range field 510 contains the date range from which employment related entries were searched for the generation of the CV topic report. In the depicted embodiment, topic list 520 contains a list of expandable CV topics as generated by CV server program 120. In the depicted embodiment, topic list 520 includes topics on customer relations, professional growth, and a particular project (Project X). Within each topic may be a number of subtopics. Entries that correspond to either the topic or subtopic are included within each respective topic or subtopic in the generated report. Employment related entries may be selected in order to view the description, or other information that was contained in the original employment related entry.

FIG. 6 depicts a block diagram of components of server 30 and client computing device 40 in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Server 30 and client computing device 40 each include communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer-readable storage media. In this embodiment, memory 606 includes random access memory (RAM) 614 and cache memory 616. In general, memory 606 can include any suitable volatile or non-volatile computer-readable storage media.

Calendaring client program 160 and CV client program 170 are stored for execution by one or more of the respective computer processors 604 of client computing device 40 via one or more memories of memory 606 of client computing device 40. Calendaring server program 100, calendar entry file 110, CV server program 120, entry crawler function 130, topics creator function 140, CV database 150, and entry rules file 180 are stored in persistent storage 608 of server 30 for execution and/or access by one of more of the respective computer processors 604 of server 30 via one or more memories of memory 606 of server 30. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer-readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Calendaring client program 160 and CV client program 170 may be downloaded to persistent storage 608 through communications unit 610 of client computing device 40. Calendaring server program 100, calendar entry file 110, CV server program 120, entry crawler function 130, topics creator function 140, CV database 150, and entry rules file 180 may be downloaded to persistent storage 608 of server 30 through communication unit 610 of server 30.

I/O interface(s) 612 allows for input and output of data with other devices that may be connected to computing system 10. For example, I/O interface 612 may provide a connection to external devices 618 such as a keyboard, keypad, a touch screen, and/or some other suitable input device. External devices 618 can also include portable computer-readable storage media such as, for example, thumb drives, portable optical or magnetic disks, and memory cards. Software and data used to practice embodiments of the present invention, e.g., calendaring server program 100, calendar entry file 110, CV server program 120, entry crawler function 130, topics creator function 140, CV database 150, and entry rules file 180, can be stored on such portable computer-readable storage media and can be loaded onto persistent storage 608 of server 30 via I/O interface(s) 612 of server 30. Software and data used to practice embodiments of the present invention, e.g., calendaring client program 160 and CV client program 170, can be stored on such portable computer-readable storage media and can be loaded onto persistent storage 608 of client computing device 40 via I/O interface(s) 612 of client computing device 40. I/O interface(s) 612 also connect to a display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1-7. (canceled)

8. A computer program product for compiling information suitable for assisting in creating or updating curriculum vitae (CV), the computer program product comprising:
one or more computer-readable storage media and program instructions stored on the one or more computer-readable storage media, the program instructions comprising:
program instructions to analyze a plurality of entries to determine that one or more entries of the plurality of entries contains information relevant to creating or updating a CV;
program instructions to organize the one or more entries containing information relevant to creating or updating a CV; and
program instructions to generate a report suitable for assisting in creating or updating a CV using the entries organized into the one or more topics.

9. The computer program product of claim 8, wherein program instructions to organize the one or more entries containing information relevant to creating or updating a CV comprise:
program instructions to determine one or more topics for each of the one or more entries based on the information relevant to creating or updating a CV contained in each entry of the one or more entries containing information relevant to creating or updating a CV; and
program instructions to group the one or more entries based on the one or more topics.

10. The computer program product of claim 8, wherein the plurality of entries are entries in a calendar program.

11. The computer program product of claim 8, wherein program instructions to analyze a plurality of entries to determine that one or more entries of the plurality of entries contains information relevant to creating or updating a CV comprise:
program instructions to analyze the plurality of entries to determine that one or more entries of the plurality of entries includes a tag, wherein the tag indicates that an entry contains information relevant to creating or updating a CV.

12. The computer program product of claim 8, wherein program instructions to analyze a plurality of entries to determine that one or more entries of the plurality of entries contains information relevant to creating or updating a CV comprise:
program instructions to access a first list of one or more rules that establish whether information is relevant to creating or updating a CV; and
program instructions to determine one or more entries of the plurality of entries that satisfy the first list of one or more rules.

13. The computer program product of claim 8, wherein program instructions to organize the one or more entries containing information relevant to creating or updating a CV comprise:
program instructions to compare each respective entry of the one or more entries to existing topics based on the information relevant to creating or updating a CV contained in the one or more entries using a second list of one or more rules;
program instructions to determine that an existing topic corresponds to the information relevant to creating or updating a CV contained in each respective entry; and
program instructions to add each respective entry to the existing topic.

14. The computer program product of claim 8, wherein program instructions to organize the one or more entries containing information relevant to creating or updating a CV comprise:
program instructions to compare each respective entry of the one or more entries to existing topics based on the information relevant to creating or updating a CV contained in the one or more entries using a second list of one or more rules;
program instructions to determine that no existing topic corresponds to the information relevant to creating or updating a CV contained in each respective entry; and
program instructions to add each respective entry to a new topic.

15. A computer system for compiling information suitable for assisting in creating or updating curriculum vitae (CV), the computer system comprising:
one or more computer processors, one or more computer-readable storage media, and program instructions stored on the computer-readable storage media for execution by at least one of the one of the one or more processors, the program instructions comprising:
program instructions to analyze a plurality of entries to determine that one or more entries of the plurality of entries contains information relevant to creating or updating a CV;
program instructions to organize the one or more entries containing information relevant to creating or updating a CV; and
program instructions to generate a report suitable for assisting in creating or updating a CV using the entries organized into the one or more topics.

16. The computer system of claim 15, wherein program instructions to organize the one or more entries containing information relevant to creating or updating a CV comprise:
program instructions to determine one or more topics for each of the one or more entries based on the information relevant to creating or updating a CV contained in each entry of the one or more entries containing information relevant to creating or updating a CV; and
program instructions to group the one or more entries based on the one or more topics.

17. The computer system of claim 15, wherein the plurality of entries are entries in a calendar program.

18. The computer system of claim 15, wherein program instructions to analyze a plurality of entries to determine that one or more entries of the plurality of entries contains information relevant to creating or updating a CV comprise:
program instructions to analyze the plurality of entries to determine that one or more entries of the plurality of entries includes a tag, wherein the tag indicates that an entry contains information relevant to creating or updating a CV.

19. The computer system of claim 15, wherein program instructions to analyze a plurality of entries to determine that one or more entries of the plurality of entries contains information relevant to creating or updating a CV comprise:
program instructions to access a first list of one or more rules that establish whether information is relevant to creating or updating a CV; and
program instructions to determine one or more entries of the plurality of entries that satisfy the first list of one or more rules.

20. The computer system of claim 15, wherein program instructions to organize the one or more entries containing information relevant to creating or updating a CV comprise:
program instructions to compare each respective entry of the one or more entries to existing topics based on the information relevant to creating or updating a CV contained in the one or more entries using a second list of one or more rules;
program instructions to determine that an existing topic corresponds to the information relevant to creating or updating a CV contained in each respective entry; and
program instructions to add each respective entry to the existing topic.
